(19) United States
(12) Patent Application Publication
(10) Pub. No.: US 2010/0270871 A1
(43) Pub. Date: Oct. 28, 2010

(54) Electric generating system of a vehicle

(76) Inventor: Hung-Chien Chou, Taichung City (TW)

Correspondence Address: HAYNES AND BOONE, LLP;IP Section, 2323 Victory Avenue, Suite 700, Dallas, TX, 75219, US

(21) Appl. No.: 12/590,743

(22) Filed: Nov. 12, 2009

(30) Foreign Application Priority Data
Apr. 22, 2009 (CN) 200910135129.2

(51) Int. Cl. H02K 35/00

(52) U.S. Cl. 310/30; 310/15

(57) ABSTRACT

An electric generating system includes a vehicle having at least two mechanical components which are capable of reciprocating movements relative to each other; and an electric generator connected to the mechanical components and including a magnet unit and a conductor winding unit. The reciprocating movements include an interaction of the conductor winding unit and magnetic flux lines of the magnet unit to generate electricity. The electricity can be produced from vibration energy induced by shock.

### CROSS-REFERENCE TO RELATED APPLICATION

This application claims priority of Chinese Patent Application No. 200910135129.2 filed on Apr. 22, 2009.

### BACKGROUND OF THE INVENTION

1. Field of the Invention

The invention relates to an electric generating system, more particularly an environmentally clean electric generating system of a vehicle.

2. Description of the Related Art

Traveling with a bicycle is now one of the most popular leisure activities. To fulfill the needs of cyclists, many bicycles are provided with electric and electronic devices, such as electronic maps, distance meters, lighting and alarming lamps, etc. Commonly used power sources for such devices are battery cells which are easily available. However, battery cells are highly polluting energy sources which are not environmentally friendly. Other power sources for the electric or electronic devices are dynamos or electric generators which can generate electricity by converting a mechanical motion of a bicycle wheel into electrical energy.

Referring to FIG. 1, an early bicycle dynamo 1 has a rotor with one end disposed in friction contact with a wheel rim 2 of a bicycle so that the rotor can be rotated by the wheel rim 2 and electricity can be outputted through an output end 4. However, as substantial frictional forces are produced between the wheel rim 2 and the dynamo 1 at the beginning of pedaling a bicycle, the frictional forces can be a heavy burden to a rider who has no strong leg force.

Referring to FIG. 2, a hub dynamo 6 is connected to a hub 5 at the center of a wheel rim 7. When the wheel rim 7 rotates, a rotor connected to an outer periphery of the hub 5 is rotated, and electricity produced in a stator is delivered outwardly through a central hollow shaft 8. Although the hub dynamo 6 consumes less of the energy supplied by the rider compared to the dynamo 1, it is expensive and hence uneconomical.

Like the aforesaid prior art, most of electric generators currently used in bicycles are of the type which needs to rely on motions of bicycle wheels driven by a rider. Thus, in order to generate electricity, the rider has to supply energy to an electric generator by applying additional leg force to pedals of the bicycle.

### SUMMARY OF THE INVENTION

Therefore, a main object of the present invention is to provide an electric generating system of a vehicle with a simple construction, which can generate electricity without consuming any energy supplied to the vehicle by a user of the vehicle.

Another object of the present invention is to provide an electric generating system of a vehicle, which can produce electricity from vibration motions of the vehicle induced by shock.

According to the present invention, an electric generating system comprises: a vehicle including at least two mechanical components which are capable of reciprocating movements relative to each other; and an electric generator connected to the mechanical components, and including a magnet unit and a conductor winding unit. The reciprocating movements induce an interaction of the conductor winding unit and magnetic flux lines of the magnet unit to generate electricity.

### BRIEF DESCRIPTION OF THE DRAWINGS

Other features and advantages of the present invention will become apparent in the following detailed description of the preferred embodiments with reference to the accompanying drawings, of which:

FIG. 1 shows a conventional bicycle dynamo;

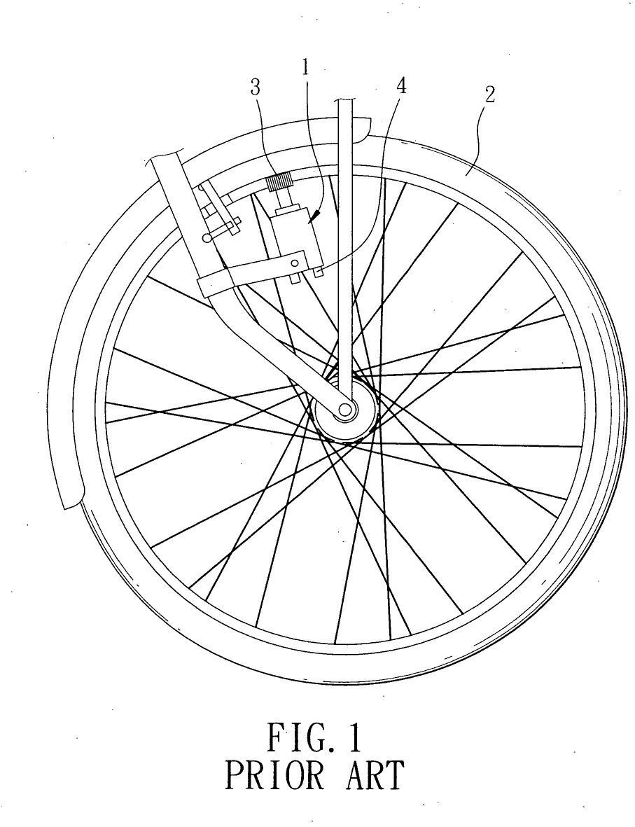

FIG. 2 shows a conventional hub dynamo;

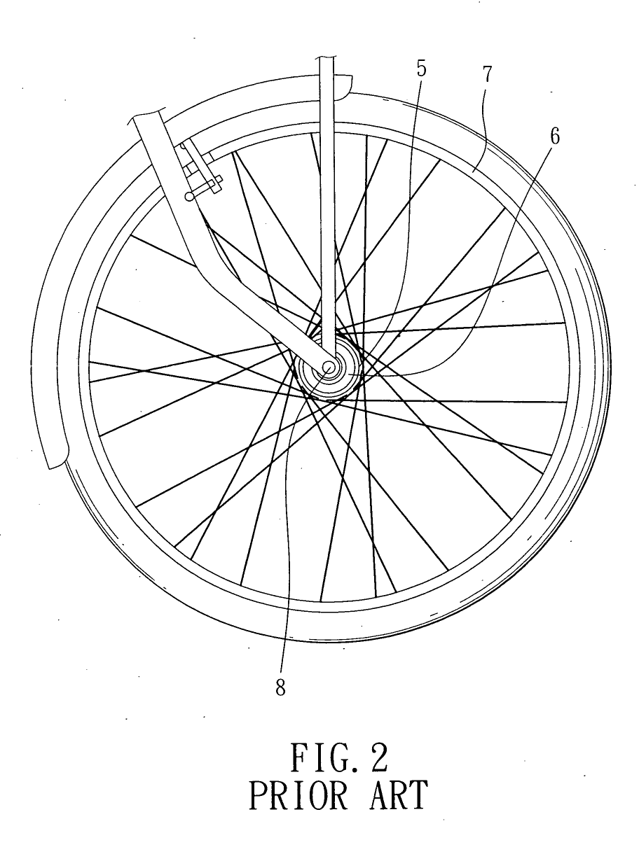

FIG. 3 is an elevation view showing an electric generating system according to the first preferred embodiment of the present invention;

FIG. 4 is an elevation view showing an electric generating system according to the second preferred embodiment of the present invention;

FIG. 5 is a fragmentary perspective view showing the electric generating system of FIG. 4;

FIG. 6 is an elevation view showing an electric generating system according to the third preferred embodiment of the present invention;

FIG. 7 is a sectional view taken along line VII-VII of FIG. 6;

FIG. 8 is a sectional view taken along line VIII-VIII of FIG. 7;

FIG. 9 is a sectional view taken along line IX-IX of FIG. 7; and

FIG. 10 is a schematic view showing an electric generating system according to the fourth preferred embodiment of the present invention.

### DETAILED DESCRIPTION OF THE PREFERRED EMBODIMENTS

Before the present invention is described in greater detail with reference to the accompanying preferred embodiments, it should be noted herein that like elements are denoted by the same reference numerals throughout the disclosure.

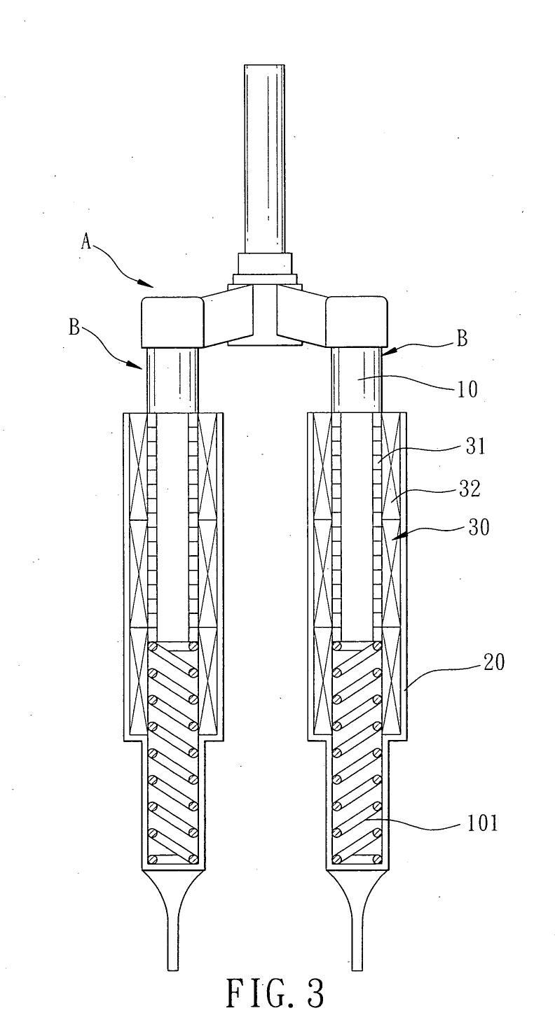

Referring to FIG. 3, there is shown an electric generating system according to a first preferred embodiment of the present invention which includes a bicycle (A) (only a portion of the bicycle is shown) and an electric generator 30. The bicycle (A) includes a shock-absorbing type front fork that has at least two mechanical components which are capable of reciprocating movements relative to each other. In particular, the front fork has a pair of fork members (B) each of which includes an inner tube 10 and an outer tube 20 as the mechanical components. The outer tube 20 is telescopically sleeved around the inner tube 10. A shock-absorbing member in the form of a coiled spring 101 is disposed between the inner and outer tubes 10 and 20. The inner and outer tubes 10, 20 are movable reciprocatingly and linearly relative to each other.

The electric generator 30 includes a magnet unit 31 fixed to the inner tube 10, and a conductor winding unit 32 disposed around the magnet unit 31 and connected to the outer tube 20.

When the bicycle moves upwardly and downwardly on a road having rising and indenting surfaces, the outer tube 20 moves reciprocatingly and linearly relative to the inner tube 10 so that the conductor winding unit 32 moves relative to the magnet unit 31, and a current is generated in the conductor winding unit 32. The generated current can be supplied to a lighting or alarming lamp, such as an LED lamp attached to the bicycle, or other electric or electronic devices carried by a rider (such as radio, MP3 etc.). The electric generating system is environmentally clean and saves energy. Electricity is generated by using vibration energy induced by shock, and does not utilize any energy supplied by a user for driving the wheels of the bicycle.

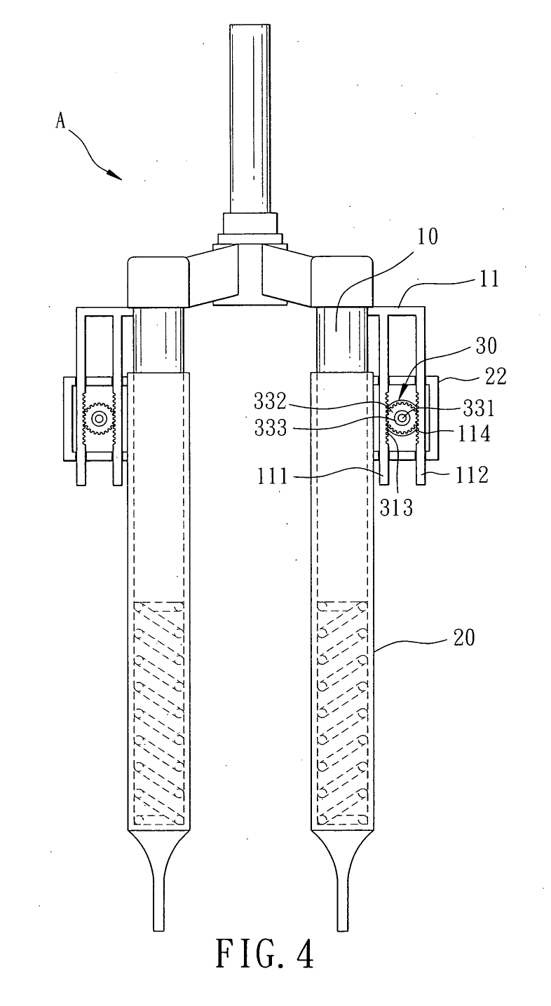

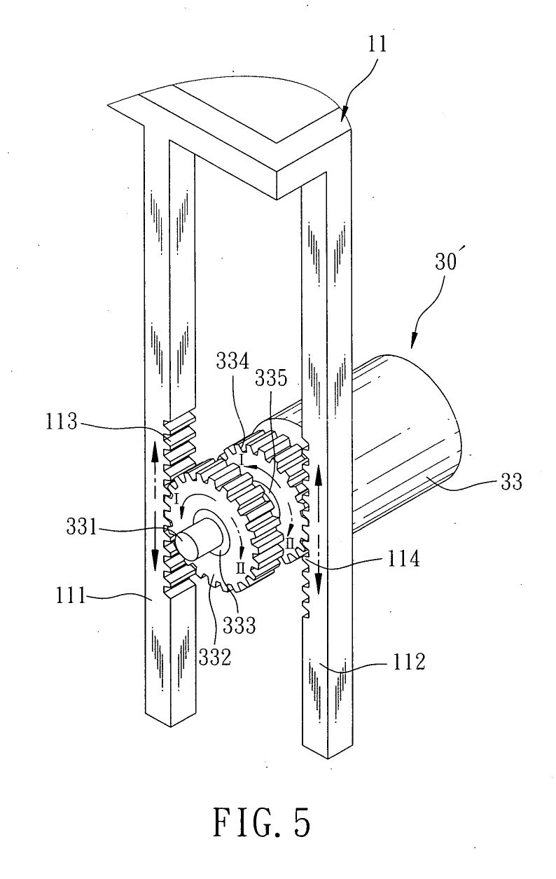

Referring to FIGS. 4 and 5, there is shown a second preferred embodiment of the present invention, which differs from the first preferred embodiment as follows: The bicycle (A) further includes a driving unit 11 connected to the inner tube 10, and a housing 22 connected to the outer tube 20. The electric generator 30′ has a generator case 33 supported by the housing 22 and receiving the magnet unit (not shown) and the conductor winding unit (not shown), a rotary shaft 331 connected to one of the magnet unit 31 and the conductor winding unit 32 and extending outwardly of the generator case 33, first and second gears 332, 334 disposed around the rotary shaft 331, a single-direction first bearing unit 333 disposed between the rotary shaft 331 and the first gear 332, and a single-direction second bearing unit 335 disposed between the rotary shaft 331 and the second gear 334. The first and second bearing units 333, 335 permit the rotary shaft 331 to rotate only in a single direction.

The driving unit 11 includes first and second rack bars 111, 112 which are connected in parallel to the inner tube 10 and which are respectively formed with first and second rack teeth 113, 114. The rotary shaft 331 is disposed between the first and second rack bars 111, 112. The first rack bar 111 engages the first gear 332, and the second rack bar 112 engages the second gear 334 so that the first and second gears 332, 334 are rotated by the respective first and second rack bars 111, 112 in opposite directions. However, the first and second bearing units 333, 335 enable the rotary shaft 331 to rotate in a single direction, i.e. a first direction (I), and prevent the same from rotating in a second direction (II).

When the first and second rack bars 111, 112 move downward together with the inner tube 10, the first gear 332 is rotated in the first direction (I) so that the rotary shaft 331 rotates in the first direction through the first bearing unit 333 and generates electricity. At the same time, the second gear 334 is rotated in the second direction (II) by the second rack bar 112. However, the second gear 334 idles due to the action of the second bearing unit 335.

When the first and second rack bars 111, 112 move upward relative to the outer tube 20, the second rack bar 112 rotates the second gear 334 in the first direction (I) so that the rotary shaft 331 rotates in the first direction (I) through the second bearing unit 335 and continues to generate electricity. At the same time, the first rack bar 111 rotates the first gear 332 in the second direction (II). However, the first gear 332 idles due to the action of the first bearing unit 333.

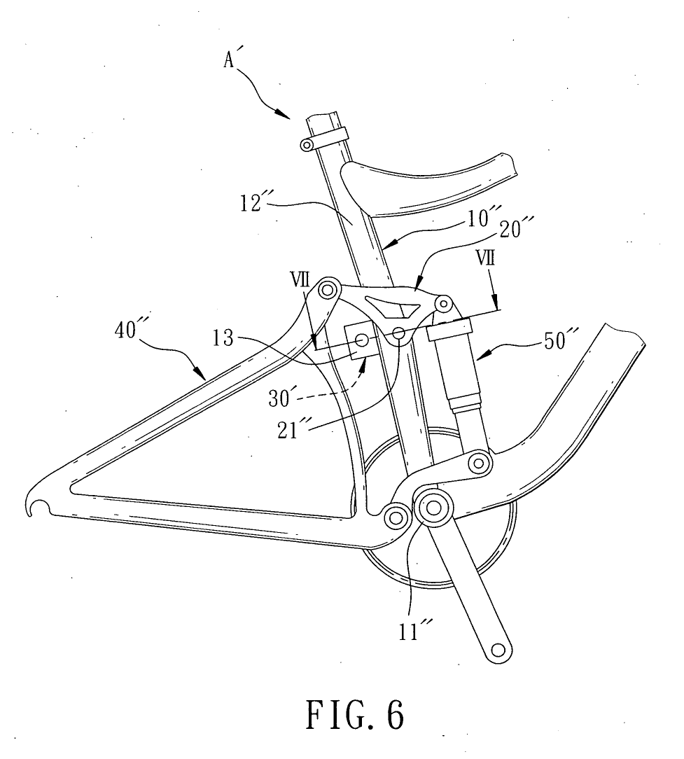

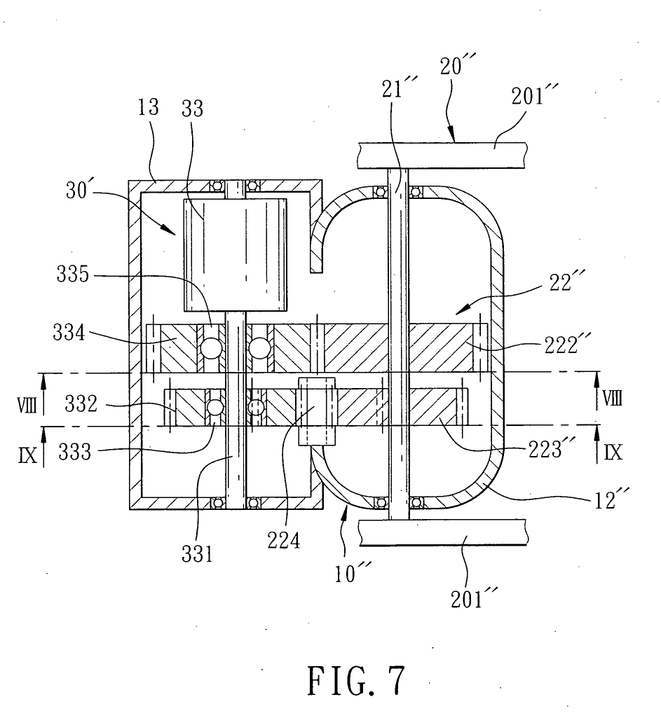

Referring to FIGS. 6 and 7, an electric generating system according to a third preferred embodiment of the present invention includes a bicycle (A′), and an electric generator 30′. The bicycle (A′) includes a bicycle frame 10″ that has a five-way tube 11″ and a seat tube 12″, a rear fork 40″, a housing 13 fixed to the seat tube 12″ of the bicycle frame 10″ to support the electric generator 30′, and a shock-absorbing system that includes a shock absorber 50″, and a lever 20″ that has two opposite ends connected respectively to the rear fork 40″ and the shock absorber 50″. The lever 20″ further has a pivot spindle 21″ fixed thereto between the rear fork 40″ and the shock absorber 50″, and a driving unit 22″ associated with the pivot spindle 21″. The pivot spindle 21″ is mounted rotatably to the bicycle frame 10″ so that the lever 20″ and the pivot spindle 21″ can rotate relative to the seat tube 12″. In this embodiment, the lever 20″, the pivot spindle 21″ and the bicycle frame 10″ are the mechanical components of the bicycle (A′) which are connected to the electric generator 30′. The lever 20″ has two lever plates 201″. The pivot spindle 21″ has two ends fixed to the lever plates 201″ and extends transversely through the seat tube 12″.

The generator case 33 and the rotary shaft 331 of the electric generator 30′ are supported in the housing 13. The housing 13 is communicated spatially with an interior of the seat tube 12″. The driving unit 22″ includes third and fourth gears 222″, 223″ mounted to the pivot spindle 21″ within the seat tube 12″, and a fifth gear 224″ disposed inside the seat tube 12″ and the housing 13. The third gear 222″ engages the second gear 334. The fifth gear 224″ is disposed between and engages the first and fourth gears 332, 223″. Therefore, when the third and fourth gears 222″ and 223″ rotate along with the pivot spindle 21, the first and second gears 332,334 are rotated in opposite directions. However, the first and second bearing units 333, 335 enables the rotary shaft 331 to rotate only in a single direction, i.e. the second direction (II).

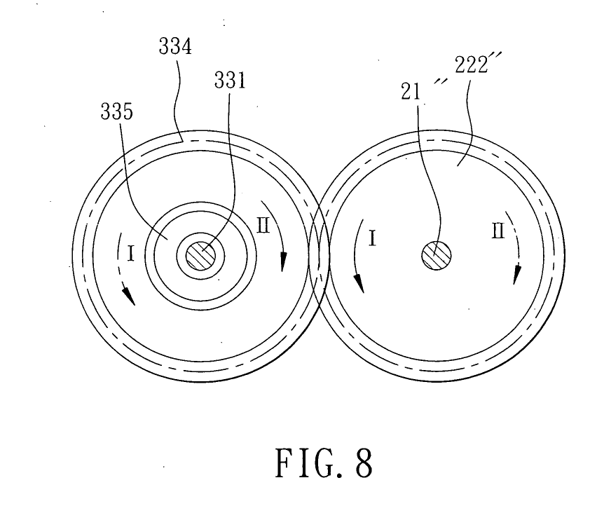

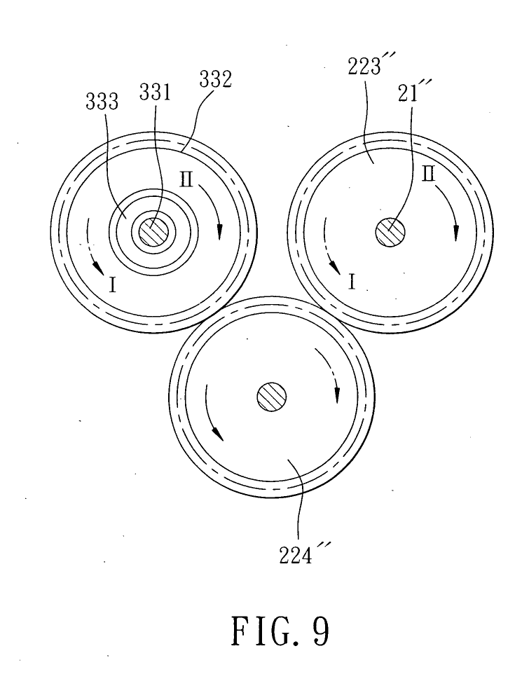

When the rear fork 40″ moves upward and downward, the lever 20″ together with the pivot spindle 21″ rotates reciprocatingly. Referring to FIGS. 8 and 9 in combination with FIG. 7, when the pivot spindle 21″ rotates in the first direction (I), the third gear 222″ causes the second gear 334 to rotate in the second direction (II), thereby driving the rotary shaft 331 in the second direction (II) through the second bearing unit 335 and generating electricity. At the same time, the fourth and fifth gears 223″, 224″ cause the first gear 332 to rotate in the first direction (I). However, the first gear 332 idles because of the action of the first bearing unit 333.

Conversely, when the pivot spindle 21″ rotates in the second direction (II), the second gear 334 rotates idly in the first direction (I) due to the action of the second bearing unit 335, and the first gear 332 rotates the rotary shaft 331 in the second direction (II) by the action of the first bearing unit 333 to generate electricity.

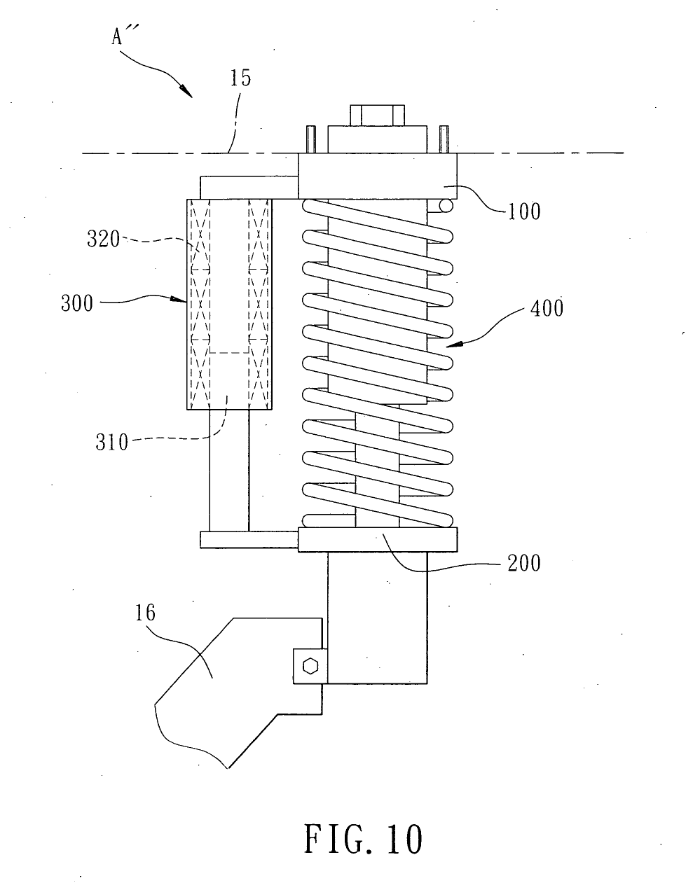

Referring to FIG. 10, an electric generating system according to the fourth preferred embodiment of the present invention includes an automobile (A″) (only a portion is shown) which includes a chassis 15, and a shock-absorbing system which includes mechanical components 100 and 200, and a shock absorber 400 connected between the mechanical components 100, 200. The upper one of the mechanical components 100, 200 is connected to the chassis 15, and the lower one of the mechanical components 100, 200 is connected to a shaft of a wheel through a connector 16.

The electric generator 300 is connected between the upper and lower mechanical components 100, 200, and has the magnet unit 310 and the conductor winding unit 320. When the mechanical component 200 moves upward and downward relative to the mechanical component 100, the electric generator 300 generates electricity. Therefore, electricity can be produced from vibration energy induced by shock when the automobile (A″) runs. The electricity as produced can be supplied to a lighting or alarming lamp, an electronic device, etc., or used to charge a battery.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. An electric generating system comprising:
a vehicle including at least two mechanical components which are capable of reciprocating movements relative to each other; and
an electric generator connected to said mechanical components, and including a magnet unit and a conductor winding unit, wherein the reciprocating movements induce an interaction of said conductor winding unit and magnetic flux lines of said magnet unit to generate electricity.

2. The electric generating system of claim 1, wherein said vehicle includes a shock-absorbing system that has said mechanical components.

3. The electric generating system of claim 2, wherein said vehicle is a bicycle, said shock-absorbing system having a shock-absorbing type front fork, said front fork including an inner tube, and an outer tube telescopically sleeved around said inner tube, said mechanical components being said inner and outer tubes.

4. The electric generating system of claim 3, wherein said magnet unit is fixed to said inner tube, and said conductor winding unit is connected to said outer tube and surrounding said magnet unit.

5. The electric generating system of claim 3, wherein said shock absorbing system further has a housing fixed to one of said inner and outer tubes, and a driving unit connected to the other one of said inner and outer tubes, said electric generator further including a generator case receiving said magnet unit and said conductor winding unit and supported by said housing, a rotary shaft connected to one of said magnet unit and said conductor winding unit and extending outwardly of said generator case, first and second gears disposed around said rotary shaft, a single-direction first bearing unit disposed between said first gear and said rotary shaft, a single-direction second bearing unit disposed between said second gear and said rotary shaft, said driving unit rotating reciprocatingly said first and second gears in opposite directions, said first and second bearing units permitting said rotary shaft to rotate only in a single direction.

6. The electric generating system of claim 5, wherein said driving unit includes first and second rack bars connected to and extending in parallel with said inner tube, said rotary shaft disposed between said first and second rack bars, said first rack bar engaging said first gear, said second rack bar engaging said second gear.

7. The electric generating system of claim 2, wherein said electric generator further includes a generator case receiving said magnet unit and said conductor winding unit, a rotary shaft connected to one of said magnet unit and said conductor winding unit and extending outwardly of said generator case, first and second gears disposed around said rotary shaft, a single-direction first bearing unit disposed between said first gear and said rotary shaft, a single-direction second bearing unit disposed between said second gear and said rotary shaft, said shock absorbing system further having a driving unit connected to one of said mechanical components and rotating reciprocatingly said first and second gears in opposite directions, said first and second bearing units permitting said rotary shaft to rotate only in a single direction.

8. The electric generating system of claim 7, wherein said vehicle further includes a bicycle frame and a rear fork, and a housing fixed to said bicycle frame and supporting said generator case, said shock-absorbing system including a shock absorber, and a lever that has two opposite ends connected respectively to said rear fork and said shock absorber, and a pivot spindle fixed to said lever between said rear fork and said shock absorber, said pivot spindle being mounted rotatably to said bicycle frame so that said lever is rotatable relative to said bicycle frame, said driving unit being associated with said pivot spindle, said mechanical components being said bicycle frame and said lever.

9. The electric generating system of claim 8, wherein said driving unit includes third and fourth gears mounted to said pivot spindle, and a fifth gear, said third gear engaging said second gear, said fifth gear being disposed between and engaging said first and fifth gears.

10. The electric generating system of claim 2, wherein said vehicle is an automobile having a chassis and a wheel, said shock absorbing system further including a shock absorber disposed between said mechanical components, one of said mechanical components being connected to said chassis, and the other one of said mechanical components being connected to said wheel, said magnet unit being connected to one of said mechanical components, said conductor winding unit being connected to the other one of said mechanical components and disposed around said magnet unit.
